(19) United States
(12) Patent Application Publication
(10) Pub. No.: US 2020/0307678 A1
(43) Pub. Date: Oct. 1, 2020

(54) Vehicle Auxiliary Steering Device Comprising Double Acting Clutch

(71) Applicant: JIYOUNGLINSYSTEM CO., LTD., Incheon (KR)

(72) Inventor: Kwang Young Yoo, Incheon (KR)

(21) Appl. No.: 16/089,682

(22) PCT Filed: Mar. 3, 2017
(86) PCT No.: PCT/KR2017/002324

§ 371 Date: Sep. 28, 2018

(30) Foreign Application Priority Data
Mar. 31, 2016 (KR) 10-2016-0039682

(51) Int. Cl. B62D 5/04; B62D 6/10

(52) U.S. Cl. CPC B62D 5/0463; F16H 1/16; B62D 5/0481; B62D 6/10

(57) ABSTRACT

The present invention relates to a vehicle auxiliary steering device comprising a double acting clutch, the device replacing a conventional motor driven power steering (MDPS) system and, more specifically, to a vehicle auxiliary steering device comprising a double acting clutch, the device transmitting power, which is generated from a power generation device rotating in one direction, through the double acting clutch to a handle shaft coupled to a steering wheel and a wheel shaft, so as to assist the direction changing ability of a vehicle, thereby having excellent safety and excellent steerability, which is transmitted to a driver, and operability (handling) of the steering wheel.

### FIELD OF THE INVENTION

The present invention relates to an auxiliary steering device for a vehicle comprising a double-acting clutch which replaces a conventional motor-driven power steering (MDPS) system, and more specifically, to an auxiliary steering device for a vehicle comprising a double-acting clutch, which transmits, through the double-acting clutch, power generated by a power generation device rotating in one direction to a wheel shaft connected to a steering wheel and an axle so as to assist the steering of the vehicle, thereby providing excellent safety and improving the driver's steerability and operability (handling) of the steering wheel.

### DESCRIPTION OF RELATED ART

A steering device is a device that allows a driver to change the traveling direction of a vehicle freely as needed by turning a steering wheel and is an auxiliary device that allows the driver to drive the vehicle in a desired direction by changing the center of rotation of the front wheels of the vehicle.

In order to steer the wheels while the vehicle is stopped, it is necessary to turn the steering wheel by applying a force greater than the friction between the wheels and the road, and in particular, in the case where the vehicle is heavier and the tires are wider, if the friction between the tires and the road increases, the driver's steering force further increases.

An auxiliary steering device that assists the driver's operation is added to the steering apparatus, which includes a hydraulic power steering (HPS) system that uses hydraulic pressure of a hydraulic pump and a motor-driven power steering (MDPS) system (which is also called and an electric power steering (EPS) system).

The HPS system is generally heavy as it uses a hydraulic pump and hydraulic oil (about 1 liter), which incurs costs for replacing the hydraulic oil, the used hydraulic oil causes environmental contamination, and thus the MDPS system using an electric motor has become increasingly popular since the 1990s.

The MDPS system assists the steering of the vehicle by operating a drive motor appropriately depending on the speed of the vehicle, etc. in response to signals detected by various sensors connected to the steering wheel and has excellent performance and improved fuel efficiency by reducing the number of components and the weight of the system compared to the existing HPS system.

As a prior art that relates to an auxiliary steering advice comprising a double-acting clutch, as shown in FIG. 9A, Korean Patent No.: 10-0854472, entitled “Electric Power Steering Apparatus” (hereinafter referred to as “prior art 1”) discloses an electric power steering apparatus, in which on the outer periphery of a bearing for supporting a worm rotating with the rotation of a steering assist motor inside the housing, elastic members are provided to restrain the bearing from moving in the radial direction thereof; the force restraining the movement of the bearing in the radial direction is made different depending on the position in the main (peripheral) direction thereof; a portion of the elastic member, in which the force restraining the movement of the bearing in the radial (centrifugal) direction is small, energizes the worm to the meshing position of the worm and a worm wheel; another portion, in which the force restraining the movement is large, restrains the worm from moving along the lead of the worm wheel; and with this configuration, the elastic members can reduce the amount of backlash at the meshing portion of the worm and the worm wheel and can make the rotation torque applied to the meshing portion of the worm gears relatively small.

As another prior art, as shown in FIG. 9B, Korean Patent No.: 10-1100671, entitled “Auxiliary Electric Power Steering Apparatus” (hereinafter referred to as “prior art 2”) discloses an auxiliary electric power steering which applies an auxiliary steering force to a rack bar using a linear pulling means which is wound and unwound by a drive means driven during the operation of a steering wheel.

However, the prior art MDPS system, including the above-mentioned prior arts 1 and 2, assists the steering of the vehicle, as shown in FIG. 1A; however, in the event of a failure or breakage in the drive motor driving the MDPS system, it may be an element that interferes with the driver's operation of the steering wheel.

Moreover, due to excessive intervention of the MDPS system in handling the steering wheel, the response is slower than the speed at which the automobile is driven, which makes it difficult to operate the steering wheel during an overspeed condition, makes the driver feel uncomfortable, and causes non-smooth operation.

For example, after a full turn of the steering wheel, the steering wheel returns to its original position later than expected due to a delay in the self-centering of the steering wheel, which makes the driver get confused.

In addition, the steering wheel should transmit the road condition in the form of vibration to the driver and, through this feedback, allow the driver to determine the road condition and the grip of the tires to help safe driving; however, due to excessive intervention of the MDPS system, the feedback between the driver and the steering wheel is disconnected, which is problematic.

The normal operation current of the electric motor driving the MDPS system is as high as about 78 A, which is close to the capacity of the alternator/generator installed in a conventional gasoline vehicle.

That is, the conventional MDPS system uses a drive motor rotating in both directions to temporarily provide excess current to the drive motor for rapid response during vehicle driving, which causes a counter electromotive force, and as a result, most of the electric capacity required for the vehicle is consumed by the drive motor of the MDPS system.

The counter electromotive force is a driving force which causes electric current to flow in a direction opposite to the desired current direction, which is the effective electromotive force acting to stop the current flowing in a predetermined direction in the system and corresponds to the action-reaction relationship in a dynamical system.

Therefore, if the system is damaged by an increased load due to an increase in power consumption in the vehicle, it is impossible to steer the vehicle due to a failure or breakage in the drive motor driving the MDPS system as described above, causing a safety problem.

This is because, when the power to the drive motor of the MDPS is interrupted, a certain amount of external force is required to turn the drive motor, and if the drive motor is directly connected to the steering system, it is impossible to ensure the torque required for steering, and thus there is a reduction gear between the drive motor and the steering system. Therefore, if the reduction ratio of the reduction gear increases, the force required to turn the drive motor should be increased, and thus a force several tens of times greater than the force usually required to turn the steering wheel is required to turn the drive motor.

Therefore, at the moment when the power to the drive motor is interrupted, the steering wheel is felt as if it is stationary, and thus the driver cannot control the vehicle in a desired direction, making the driver feel uneasy, which is problematic.

### SUMMARY OF THE INVENTION

Accordingly, the present invention has been made in an effort to solve the above-mentioned problems, and an object of the present invention is to provide an auxiliary steering device for a vehicle comprising a double-acting clutch which can replace a drive motor rotating in both direction used in a conventional motor-driven power steering (MDPS) system with a power generation device rotating in one direction with an increased lifespan, thereby providing excellent safety.

Another object of the present invention is to provide an auxiliary steering device for a vehicle comprising a double-acting clutch which does not require much current to temporarily provide the current in the opposite direction to a conventional drive motor rotating in both directions, which prevents the generation of counter electromotive force and reduces the load on the electrical system of the vehicle due to power consumption, thereby enhancing the stability of the electronic system in the vehicle.

Still another object of the present invention is to provide an auxiliary steering device for a vehicle comprising a double-acting clutch which has simple components and excellent durability and provides rapid response when the driver steers the steering wheel, thereby improving the driver's operability (handling) without any mechanical sense.

In order to achieve the above objects, the present invention provides an auxiliary steering device for a vehicle comprising a double-acting clutch, comprising: a power generation device generating power and rotating in one direction; a wheel shaft gear having a wheel shaft A provided with a steering wheel H; a double-acting clutch operating under the control of an electronic control unit (ECU) depending on the turning direction of the wheel shaft A; a mechanical connection means transmitting the power generated by the power generation device to the double-acting clutch; and a main gear located between the double-acting clutch and the wheel shaft gear and allowing the power generated by the power generation device to be transmitted to the wheel shaft gear via the double-acting clutch.

Here, the double-acting gear comprises: a first gear engaged with one side of the main gear; a second gear engaged with the other side of the main gear; a central axis located between the first gear and the second gear and coupled with the mechanical connection means; a first electromagnetic clutch allowing the first gear and the central axis to be connected/disconnected; and a second electromagnetic clutch allowing the second gear and the central axis to be connected/disconnected, wherein the first gear, the second gear, the central axis, the first electromagnetic clutch, and the second electromagnetic clutch are arranged in series on the same axis, and the first and second electromagnetic clutches operate in an opening/closing manner under the control of the electronic control unit (ECU), such that when the first electromagnetic clutch is in a closed state, the central axis and the first gear are connected, and the second electromagnetic clutch is in an open state, disconnects the central axis and the second gear and, at the same time, acts as a bearing to assist an idle operation of the second gear; and when the second electromagnetic clutch is in a closed state, the central axis and the second gear are connected, and the first electromagnetic clutch is in an open state, disconnects the central axis and the first gear and, at the same time, acts as a bearing to assist an idle operation of the first gear; and thus, when the first gear or the second gear is connected with the central axis, the power generated by the power generation device is transmitted to the wheel shaft gear, thereby assisting the operation of the steering wheel H by the driver.

Moreover, the main gear includes gear teeth formed on an upper surface B and an outer circumferential surface S such that the upper surface B is engaged with the first and second gear and the outer circumferential surface S is engaged with the wheel shaft gear, thereby connecting the double-acting clutch and the wheel shaft gear.

Prior to this, the terms or words used in the specification and claims of the present application should not be construed as being limited to ordinary or dictionary meanings, but should be construed as meanings and concepts conforming to the technical spirit of the present invention on the basis of the principle that the inventor can define the concept of the terms properly to explain his invention in the best way.

Accordingly, it should be understood that embodiments described in the specification and the configurations shown in the drawings are just the most preferred embodiments of the present invention and do not fully cover the spirit of the present invention, and thus there may be various equivalents and modifications that can replace these embodiments at the time of filing this application.

As described above, the auxiliary steering device for a vehicle comprising a double-acting clutch according to the present invention can replace the drive motor rotating in both direction used in a conventional motor-driven power steering (MDPS) system with the power generation device rotating in one direction with an increased lifespan, thereby providing excellent safety.

Moreover, the auxiliary steering device for a vehicle comprising a double-acting clutch according to the present invention does not require much current to temporarily provide the current in the opposite direction to a conventional drive motor rotating in both directions, which prevents the generation of counter electromotive force and reduces the load on the electrical system of the vehicle due to power consumption, thereby enhancing the stability of the electronic system in the vehicle.

Furthermore, the auxiliary steering device for a vehicle comprising a double-acting clutch according to the present invention has simple components and excellent durability, facilitates handling and exchange of the product, and provides rapid response when the driver steers the steering wheel, thereby improving the driver's operability (handling) without any mechanical sense.

In addition, due to the rapid response, it is possible to provide an optimal auxiliary steering device suitable for an autonomous vehicle and an optimal system of the autonomous vehicle using the same.

Additionally, even in the event of a failure or breakage in the auxiliary steering device for a vehicle comprising a double-acting clutch according to the present invention due to system damage, it is possible to easily drive the vehicle with only the steering wheel, which is a very effective invention for ensuring the safety of the driver.

### BRIEF DESCRIPTION OF THE DRAWINGS

FIG. 1A is a schematic diagram comparing a prior art MDPS system and FIG. 1B is an auxiliary steering device for a vehicle comprising a double-acting clutch according to the present invention.

FIG. 2 is a schematic diagram showing the configuration of an auxiliary steering device for a vehicle comprising a double-acting clutch according to the present invention.

FIG. 3A and FIG. 3B are a schematic diagram showing the operation of an auxiliary steering device for a vehicle comprising a double-acting clutch according to the present invention.

FIG. 4 is a schematic diagram of an auxiliary steering device for a vehicle comprising a double-acting clutch according to the present invention.

FIG. 5 is a schematic diagram showing an example of an auxiliary steering device for a vehicle comprising a double-acting clutch according to the present invention.

FIG. 6 is a schematic diagram showing an example of a double-acting clutch in an auxiliary steering device for a vehicle comprising a double-acting clutch according to the present invention.

FIG. 7 is a schematic diagram showing an example of a main gear in an auxiliary steering device for a vehicle comprising a double-acting clutch according to the present invention.

FIG. 8 is an operation flow diagram of an auxiliary steering device for a vehicle comprising a double-acting clutch according to the present invention.

FIG. 9A and FIG. 9B show representative views of prior arts over an auxiliary steering device for a vehicle comprising a double-acting clutch according to the present invention.

### DETAILED DESCRIPTION OF THE PREFERRED EMBODIMENTS

Hereinafter, the configuration and operation of an auxiliary steering device for a vehicle comprising a double-acting clutch according to the present invention will be described in detail with reference to the accompanying drawings.

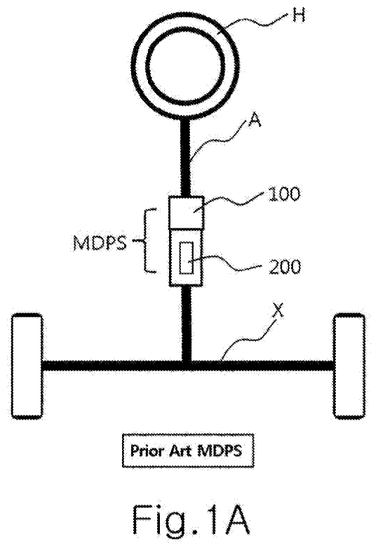

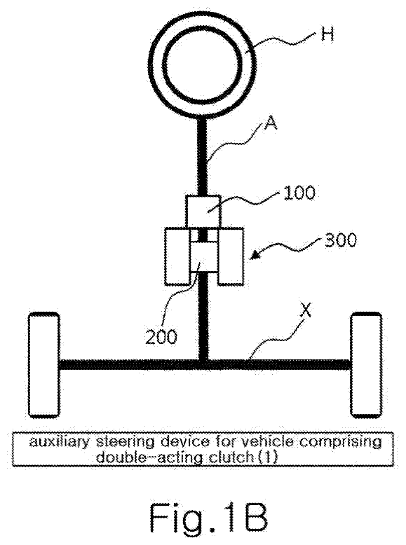

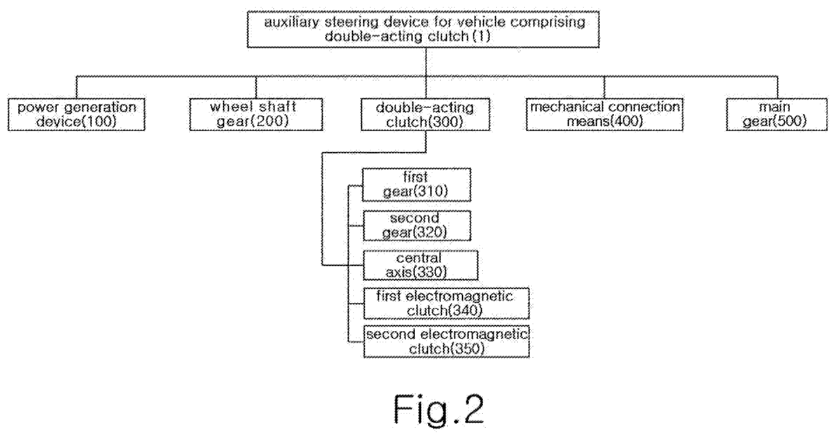

FIG. 1A is a schematic diagram comparing a prior art MDPS system and FIG. 1B is an auxiliary steering device for a vehicle comprising a double-acting clutch according to the present invention, and FIG. 2 is a schematic diagram showing the configuration of an auxiliary steering device for a vehicle comprising a double-acting clutch according to the present invention.

The present invention is directed to an auxiliary steering device 1 for a vehicle comprising a double-acting clutch, comprising: a power generation device 100 generating power and rotating in one direction; a wheel shaft gear 200 having a wheel shaft A provided with a steering wheel H; a double-acting clutch 300 operating under the control of an electronic control unit (ECU) depending on the turning direction of the wheel shaft A; a mechanical connection means 400 transmitting the power generated by the power generation device 100 to the double-acting clutch 300; and a main gear 500 located between the double-acting clutch 300 and the wheel shaft gear 200 and allowing the power generated by the power generation device 100 to be transmitted to the wheel shaft gear 200 via the double-acting clutch 300.

Here, the double-acting gear 300 comprises: a first gear 310 engaged with one side of the main gear 500; a second gear 320 engaged with the other side of the main gear 500; a central axis 330 located between the first gear 310 and the second gear 320 and coupled with the mechanical connection means 400; a first electromagnetic clutch 340 allowing the first gear 310 and the central axis 330 to be connected/disconnected; and a second electromagnetic clutch 350 allowing the second gear 320 and the central axis 330 to be connected/disconnected, wherein the first gear 310, the second gear 320, the central axis 330, the first electromagnetic clutch 340, and the second electromagnetic clutch 350 are arranged in series on the same axis, and the first and second electromagnetic clutches 340 and 350 operate in an opening/closing manner under the control of the electronic control unit (ECU), such that when the first electromagnetic clutch 340 is in a closed state, the central axis 330 and the first gear 310 are connected, and the second electromagnetic clutch 350 is in an open state, disconnects the central axis 330 and the second gear 320 and, at the same time, acts as a bearing to assist an idle operation of the second gear 320; and when the second electromagnetic clutch 350 is in a closed state, the central axis 330 and the second gear 320 are connected, and the first electromagnetic clutch 340 is in an open state, disconnects the central axis 330 and the first gear 310 and, at the same time, acts as a bearing to assist an idle operation of the first gear 310; and thus, when the first gear 310 or the second gear 320 is connected with the central axis 330, the power generated by the power generation device 100 is transmitted to the wheel shaft gear 200, thereby assisting the operation of the steering wheel H by the driver.

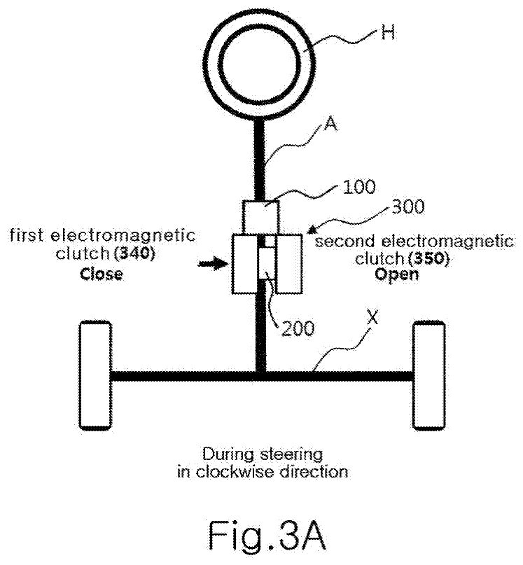

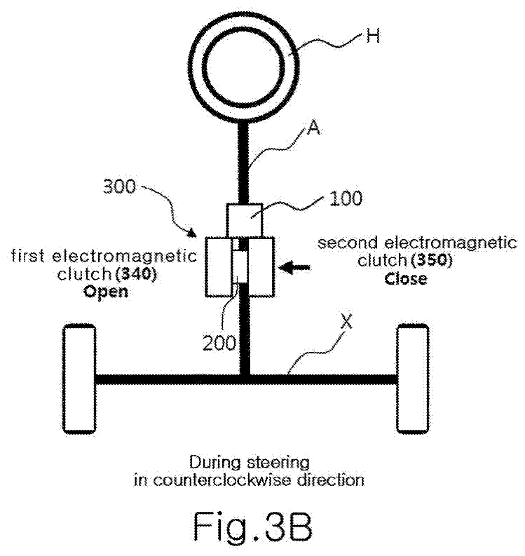

That is, as described above and shown in FIG. 3A and FIG. 3B, the double-acting clutch 300 is operated by an electronic control unit (ECU) controlling an electronic system in the vehicle and is a key component of the present invention which assists the operation of the steering wheel H by the driver during driving of the vehicle.

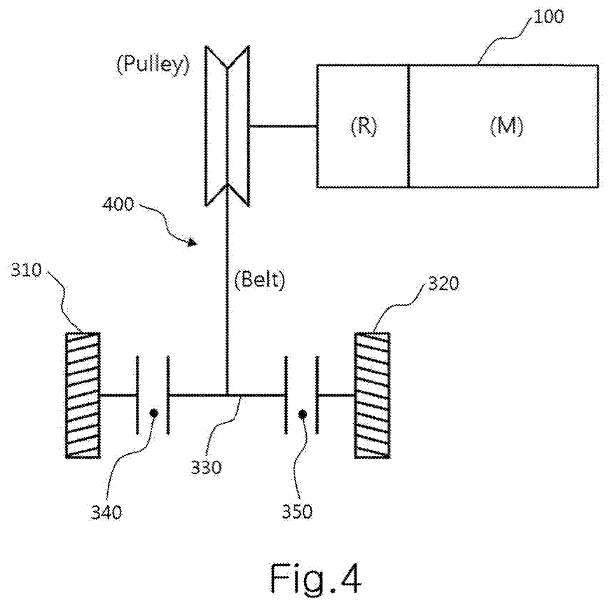

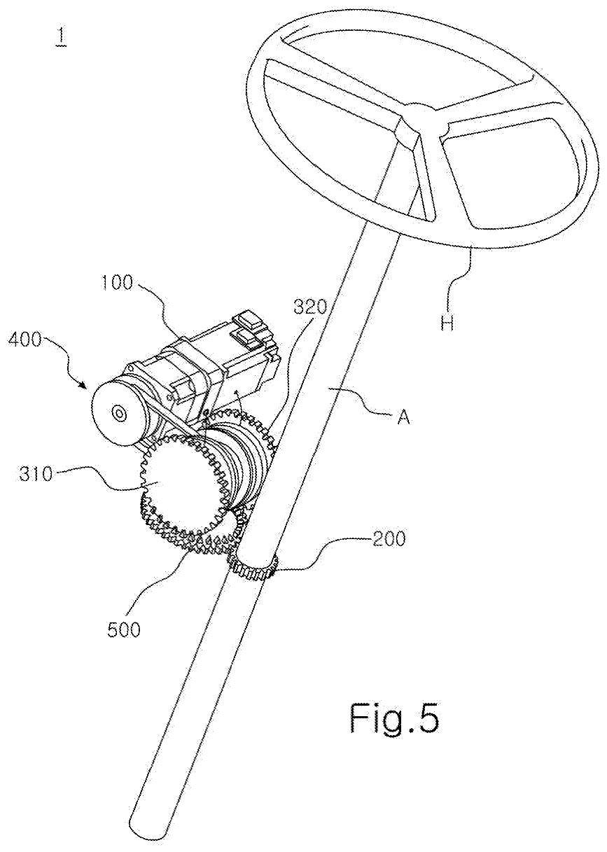

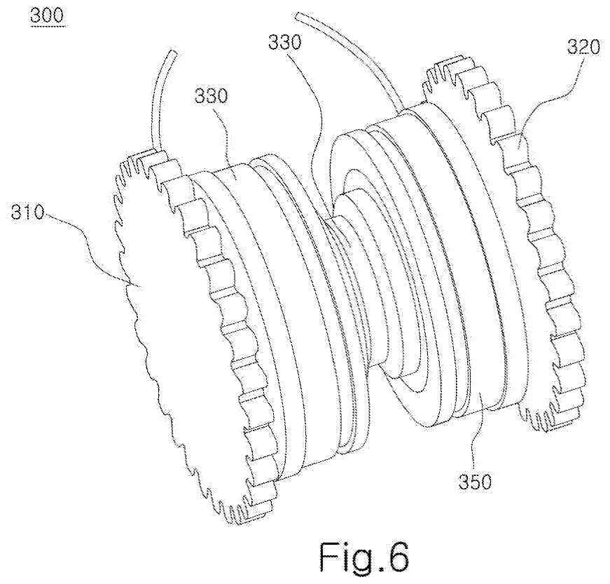

Moreover, the mechanical connection means 400 is required to transmit the power generated by the power generation device 100 rotating in one direction to the double-acting clutch 300, and in the present invention, as shown in FIGS. 4 and 5, the power can be transmitted by a combination of a pulley and a belt.

The mechanical connection means 400 plays a major role in transmitting the power generated by the power generation device 100 to the double-acting clutch 300 as described above, and thus, although not shown in the drawings, the mechanical connection means 400 can be constructed with various combinations with bevel gears, worm gears, chains, etc.

As such, the power generated by the power generation device 100 rotating in one direction is transmitted to the double-acting clutch 300 through the mechanical connection means 400, and the operation of the double-acting clutch 300, which is already controlled by the electronic control unit (ECU) due to the turn of the steering wheel H by the driver, assists the driver's operation of the steering wheel H. Here, the above-mentioned main gear 500 should be provided in the double-acting clutch 300 to transmit the power to the wheel shaft gear 200 provided with the steering wheel H.

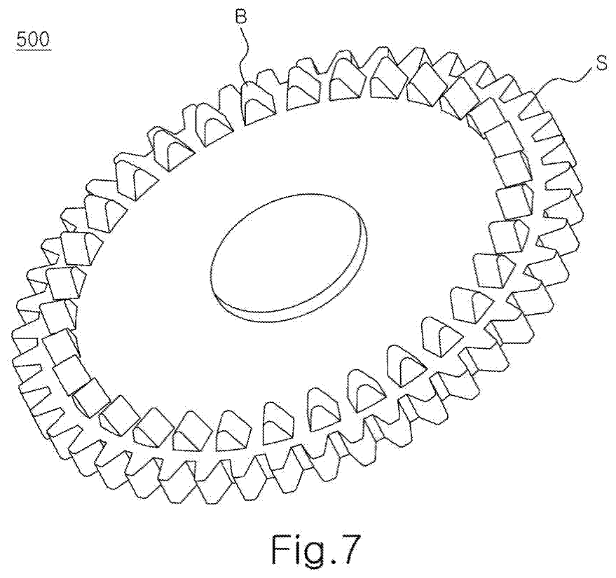

As shown in FIG. 7, the main gear 500 includes gear teeth formed on an upper surface B and an outer circumferential surface S such that the upper surface B is engaged with the first and second gear 310 and 320 and the outer circumferential surface S is engaged with the wheel shaft gear 200, thereby connecting the double-acting clutch 300 and the wheel shaft gear 200 to assist the operation of the steering wheel H by the driver.

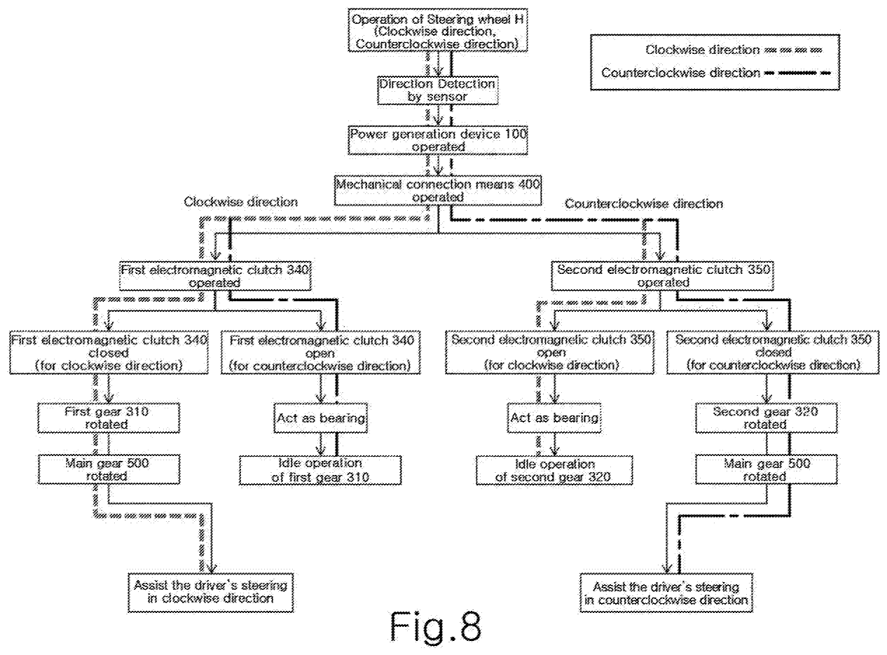

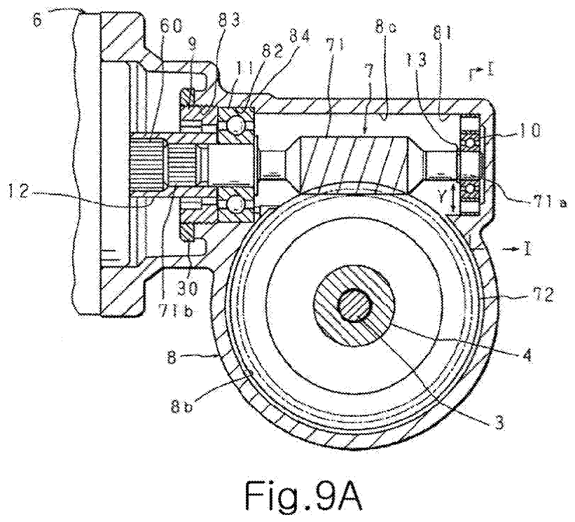

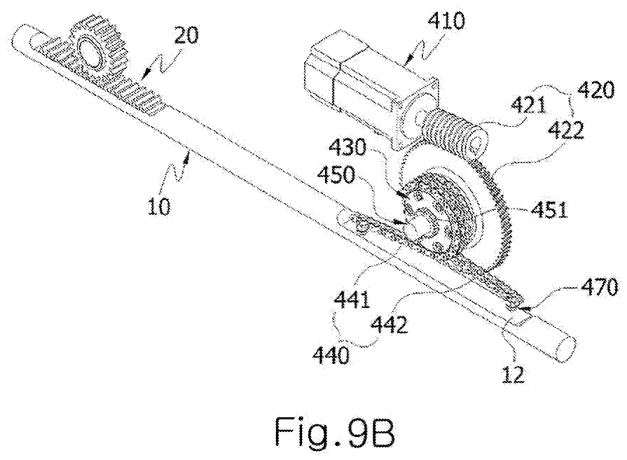

As such, the configuration and the operation principle of the present invention are as shown in FIG. 8, in which the power generation device 100 is operated by the electronic control unit (ECU) which controls the electronic system in the vehicle by detecting the turning direction by means of a torque sensor according to the driver's operation of the steering wheel H and, at the same time, the first and second clutches 340 and 350 of the double-acting clutch 300 are operated in an open or close state depending on the turning direction of the steering wheel H, thereby assisting the driver's operation of the steering wheel H.

Therefore, as described above, despite the excellent safety, the present invention is simple in configuration, which allows easy maintenance, and can be constructed with low economic costs and easily applied to the vehicle.

Moreover, the auxiliary steering device for a vehicle comprising a double-acting clutch according to the present invention can replace the conventional MDPS system, and thus the electronic control unit (ECU) applied to the existing vehicle also can be used in the present invention.

It will be apparent to those skilled in the art that the present invention is not limited to the embodiments described in the specification, but various modifications and variations can be made without departing from the spirit or scope of the invention. Accordingly, the present invention may be embodied in other specific forms without departing from the technical idea or essential features thereof, and thus the embodiments of the present invention are only illustrative and should not be interpreted as limiting the present invention.

The steering device is used to change the traveling direction of the vehicle.

In this steering device, the motor-driven power steering (MDPS) system is added, which is an auxiliary device for transmitting power to assist the driver's operation of the steering device.

However, the conventional motor-driven power steering (MDPS) system makes the driver feel uncomfortable and anxious about the safety of the vehicle.

Therefore, the auxiliary steering device for a vehicle comprising a double-acting clutch according to the present invention provides excellent safety and improves the driver's operability (handling) of the steering wheel, and thus it can contribute to promotion of various automobile industrial fields such as an inspection agency for inspecting the performance and safety of vehicles, a manufacturing industry for manufacturing automobile parts, an automobile manufacturing industry, etc.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1) An auxiliary steering device for a vehicle comprising a double-acting clutch, comprising: a power generation device generating power and rotating in one direction; a wheel shaft gear having a wheel shaft A provided with a steering wheel H; a double-acting clutch operating under the control of an electronic control unit (ECU) depending on the turning direction of the wheel shaft A; a mechanical connection means transmitting the power generated by the power generation device to the double-acting clutch; and a main gear located between the double-acting clutch and the wheel shaft gear and allowing the power generated by the power generation device to be transmitted to the wheel shaft gear via the double-acting clutch, wherein the double-acting gear comprises: a first gear engaged with one side of the main gear; a second gear engaged with the other side of the main gear; a central axis located between the first gear and the second gear and coupled with the mechanical connection means; a first electromagnetic clutch allowing the first gear and the central axis to be connected/disconnected; and a second electromagnetic clutch allowing the second gear and the central axis to be connected/disconnected, wherein the first gear, the second gear, the central axis, the first electromagnetic clutch, and the second electromagnetic clutch are arranged in series on the same axis, and the first and second electromagnetic clutches operate in an opening/closing manner under the control of the electronic control unit (ECU), such that when the first electromagnetic clutch is in a closed state, the central axis and the first gear are connected, and the second electromagnetic clutch is in an open state, disconnects the central axis and the second gear and, at the same time, acts as a bearing to assist an idle operation of the second gear; and when the second electromagnetic clutch his in a closed state, the central axis and the second gear are connected, and the first electromagnetic clutch is in an open state, disconnects the central axis and the first gear and, at the same time, acts as a bearing to assist an idle operation of the first gear; and thus, when the first gear or the second gear is connected with the central axis, the power generated by the power generation device is transmitted to the wheel shaft gear, thereby assisting the operation of the steering wheel H by the driver.
